(19) United States
(12) Patent Application Publication
(10) Pub. No.: US 2018/0351777 A1
(43) Pub. Date: Dec. 6, 2018

(54) Trustworthy Provisioning of DNS Resolutions Within Web Content

(71) Applicant: James Roskind, Redwood City, CA (US)

(72) Inventor: James Roskind, Redwood City, CA (US)

(73) Assignee: Google Inc., Mountain View, CA (US)

(21) Appl. No.: 12/883,393

(22) Filed: Sep. 16, 2010

(51) Int. Cl. H04L 29/06; H04L 29/08

(52) U.S. Cl. CPC H04L 29/06; H04L 29/0809

(57) ABSTRACT

Methods and systems for using or providing trusted DNS resolutions are provided. A method for using trustworthy DNS resolutions may include obtaining a trusted DNS resolution for a domain name within web content. The method may also include initiating a connection to a host associated with the domain name with the trusted DNS resolution. According to a further embodiment, the domain name may be resolved without requesting DNS resolution for the domain name subsequent to identifying the domain name. A system for using a trusted DNS resolution may include trustworthy resolution module and a connection module. A method for providing trustworthy DNS resolutions may include identifying a domain name to be resolved. The method may also include providing a trusted DNS resolution for the identified domain name within web content. A system for providing trustworthy DNS resolutions may include a domain identification module and a trusted resolution provision module.

### BACKGROUND

### Technical Field

Embodiments relate to applications and the World Wide Web.

### Background Art

Web browsers may use a number of protocols and standards to obtain or manage content flow. Most browsers primarily use hypertext transfer protocol (HTTP) to fetch content and web pages. Web pages are located using a uniform resource locator (URL), which identifies where the web page may be found. Web pages may be retrieved using the Internet Protocol (IP) address of the computer holding the web page content. In order to be more memorable and human friendly, an IP address or hierarchy may be represented by a hostname (such as www.google.com). A hostname is a domain name that has one or more associated IP addresses. Hostnames and other information associated with domain names may be resolved or translated to IP addresses using the Domain Name System (DNS). This DNS resolution system is sometimes referred to as the “phone book” for the Internet.

DNS resolution requires either looking in a local computer cache for a DNS resolution or querying a set of DNS servers over the network. DNS utilizes authoritative DNS resolvers to help map domain names to IP addresses. Multiple DNS resolvers may be used in order to avoid having all the information in a single, central DNS server.

DNS resolution may add extra latency, which can cause users some discomfort. FIG. 1 illustrates an exemplary system 100 that performs DNS resolution. When network traffic is required to connect to a content server 140 from browser 110, User Datagram Protocol (UDP) packets are sent to a DNS resolver, and eventually a UDP response is provided. If a DNS resolution is not selected from a local cache, such as DNS cache 110, DNS resolution is requested from interne intermediate DNS server 150, authoritative DNS server 160 or main DNS server 170 over network 130. There is a latency time required to request DNS resolution from a DNS server. For example, the latency cost for an HTTP page load is at least a) a DNS resolution; and b) a round trip to establish a TCP/IP connection. The latency cost for an HTTPS (secure HTTP) connection is a) a DNS resolution; b) a round trip to establish a TCP/IP connection; and c) a round trip to perform an SSL handshake and establish a shared key.

### BRIEF SUMMARY

The embodiments described below include systems and methods relating to the use or provision of trustworthy domain name system (DNS) resolutions. Trustworthy DNS resolutions may be relied upon as being true DNS resolutions for a domain name. For instance, trusted DNS resolutions for SSL enabled web sites may be relied upon for initiating secure SSL connections. According to an embodiment, a method for using trustworthy DNS resolutions may include obtaining a trusted DNS resolution for a domain name within web content. The method may also include initiating a connection to a host associated with the domain name with the trusted DNS resolution. According to a further embodiment, the domain name may be resolved without requesting DNS resolution for the domain name subsequent to identifying the domain name.

According to another embodiment, a method for providing trustworthy DNS resolutions may include identifying a domain name to be resolved. The method may also include providing a trusted DNS resolution for the identified domain name within web content.

According to an embodiment, a system for using trustworthy DNS resolutions may include a trustworthy resolution module configured to obtain a trusted DNS resolution for a domain name from web content. The system may also include a connection module configured to connect to a host associated with the domain name with the trusted DNS resolution.

According to another embodiment, a system for providing trustworthy DNS resolutions may include a domain identification module configured to identify a domain name to be resolved. The system may also include a trustworthy resolution provision module configured to provide a trusted DNS resolution for the identified domain name within web content.

Further embodiments, features, and advantages, as well as the structure and operation of the various embodiments are described in detail below with reference to accompanying drawings.

### BRIEF DESCRIPTION OF THE FIGURES

Embodiments are described with reference to the accompanying drawings. In the drawings, like reference numbers may indicate identical or functionally similar elements. The drawing in which an element first appears is generally indicated by the left-most digit in the corresponding reference number.

FIG. 1 is a diagram showing an existing system for DNS resolution.

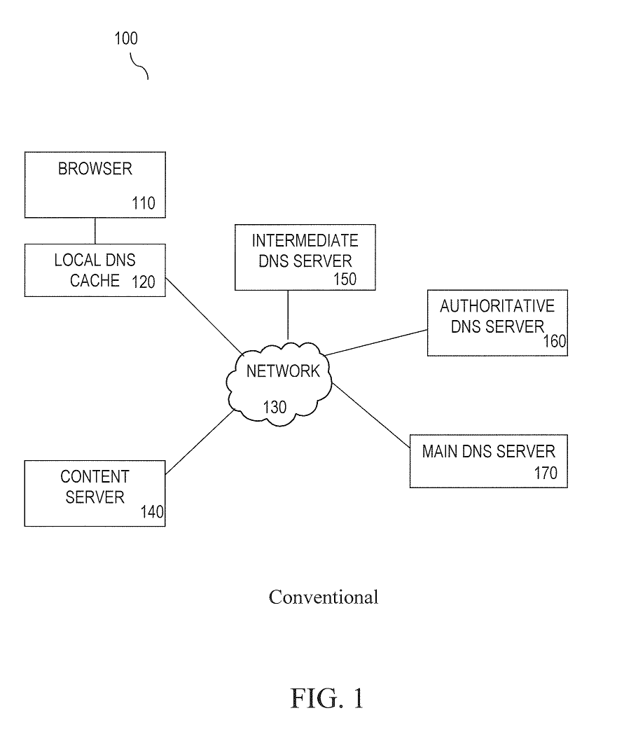

FIG. 2 is a diagram of a system for using trustworthy DNS resolutions, according to an embodiment.

FIG. 3 is a diagram of a system for using trustworthy DNS resolutions, according to an embodiment.

FIG. 4 is a diagram of a system for providing trustworthy DNS resolutions, according to an embodiment.

FIG. 5 is a flowchart illustrating a method for using trustworthy DNS resolutions, according to an embodiment.

FIG. 6 is a flowchart illustrating a method for providing trustworthy DNS resolutions, according to an embodiment.

### DETAILED DESCRIPTION

Embodiments described herein refer to illustrations for particular applications. It should be understood that the invention is not limited to the embodiments. Those skilled in the art with access to the teachings provided herein will recognize additional modifications, applications, and embodiments within the scope thereof and additional fields in which the embodiments would be of significant utility.

When a content provider provides a uniform resource locator (URL) that points to additional sites, a browser typically has to request a DNS resolution on the embedded host name prior to obtaining the content from the additional sites or subresources. To reduce latency, a content provider may provide a DNS resolution, or DNS to IP address translation, along with the host name. For security reasons, a browser cannot typically trust such a proposed resolution from a content provider. For instance, client use of a misstated or malicious resolution, beyond for example a handshake, could allow a client application to violate security policy and provide cookies for a misresolved domain to a server at the misstated IP address. However, if the URL is a secure HTTP (HTTPS) URL, then the DNS resolution can automatically be validated during the connection phase. As a result, embedding such translation hints in content can significantly reduce page load latency. Such a mechanism is trustworthy enough for SSL connectivity.

Latency may be reduced for content loaded from secondary domains. This may also apply to content of an HTTPS connection. The latency cost for an HTTPS connection is a) a DNS resolution; b) a round trip to establish a TCP/IP connection; and c) a round trip to perform an SSL handshake and establish a shared key. Embodiments described below may reduce the latency cost of an HTTPS connection to: b) a round trip to establish a TCP/IP connection; and c) a round trip to perform an SSL handshake. Since the cost of a DNS resolution typically exceeds that of a round trip on a TCP/IP connection, subresource fetching from SSL enabled sites may be faster than HTTP connection fetching.

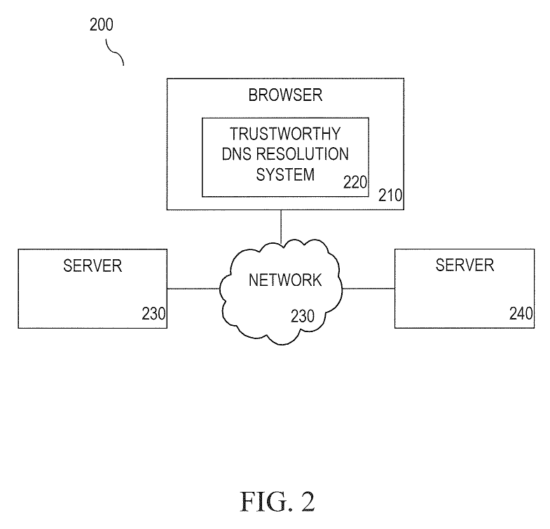

FIG. 2 shows exemplary system 200 for using trustworthy DNS resolutions, according to an embodiment. System 200 shows browser 210 and trustworthy DNS resolution system 220, which may be used to connect to server 230 or server 240 over one or more networks 130. Browser 210 and trustworthy DNS resolution system 220 may be coupled directly or indirectly. According to an embodiment, browser 210 may include any device, application or module that enables a user or computer to navigate and/or retrieve data from another data source, typically over a network. Browser 210 may include any conventional web browser such as those that are widely available. Browser 210 may also be a multi-process browser such as CHROME available from Google Inc. According to a further embodiment, browser 210 may also be configured to use any number of protocols, including protocols such as HTTP, FTP, and underlying protocols such as TCP/IP or UDP. Network(s) 230 may be any type of data network or combination of data networks including, but not limited to, a local area network (LAN), a medium area network, or a wide area network such as the Internet. Browser 210 may also be configured to support or interact with any number of world wide web protocols, applications or services.

Browser 210 and/or resolver information system 220 may exist within or be executed by hardware in a computing device. For example, browser 210 and/or trustworthy DNS resolution system 220 may be software, firmware, or hardware or any combination thereof in a computing device. A computing device can be any type of computing device having one or more processors. For example, a computing device can be a workstation, mobile device (e.g., a mobile phone, personal digital assistant, or laptop), computer, game console, set-top box, kiosk, embedded system or other device having at least one processor and memory. A computing device may include a communication port or I/O device for communicating over wired or wireless communication link(s). Browser 210 and trustworthy DNS resolution system 220 may be located on the same or different computing devices.

According to an embodiment, browser 210 may be configured to connect to another server, such as server 230 or server 240. The connection may be a secure sockets layer (SSL) connection. Browser 210 may use a trusted DNS resolution received from trustworthy DNS resolution system 220 to connect to a domain name.

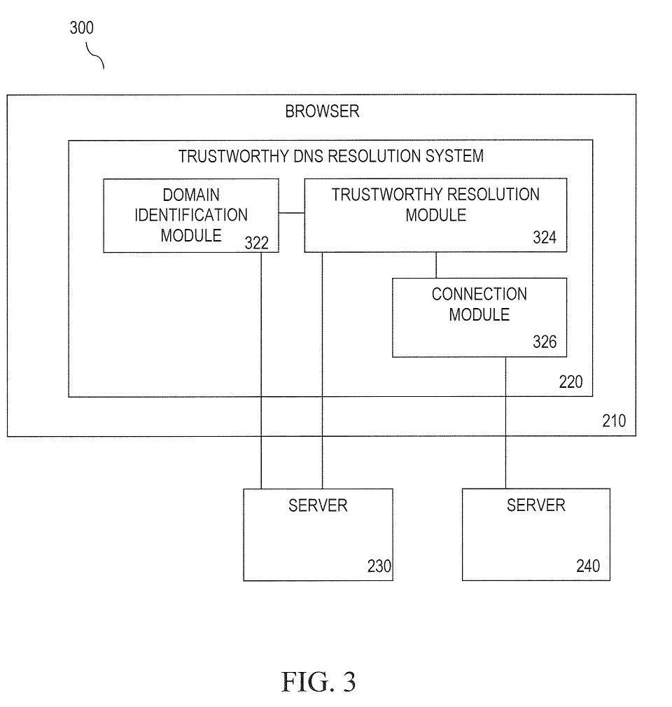

FIG. 3 illustrates an exemplary system 300 for using trustworthy DNS resolutions, according to an embodiment. System 300 includes browser 210 and trustworthy DNS resolution system 220 that may connect to server 230 and/or server 240. Trustworthy DNS resolution system 220 may include domain identification module 322, trustworthy resolution module 324 and connection module 326. These components may be coupled together directly or indirectly.

According to an embodiment, domain identification module 322 may be configured to identify a domain name to be resolved. Domain identification module 322 may automatically identify proposed resolutions based on scanning or parsing of content. For example, a hypertext markup language (HTML) renderer may scan content and extract suggested DNS resolutions. In some cases, domain names to be resolved may be determined from a web page or search results. In other cases, domain names to be resolved may be received from another component or data source.

Trustworthy resolution module 324 may be configured to obtain and use DNS resolution information, according to an embodiment. DNS resolutions may be obtained without requesting DNS resolution from an operating system DNS cache, local DNS resolver, or a global DNS resolver for the domain name subsequent to identifying the domain name. In other words, a DNS resolution may have already been performed at some time earlier than when the domain name to be resolved is identified. In other cases, a DNS resolution may have been generated. An existing DNS resolution is obtained upon identification of the domain name to be resolved rather than requesting resolution after the domain name is identified. Trustworthy resolution module 324 may also be configured to determine whether a DNS resolution is trusted. Trustworthy resolution module 324 may automatically validate the trusted DNS resolution during a secure sockets layer (SSL) connection phase.

Trustworthy resolution module 324 may obtain DNS resolutions from web content, according to an embodiment. DNS resolutions may be obtained from or provided within a web page, such as a search page or a web page containing links. Resolutions may be contained in HTML, such as within an HTML tag field such as <link rel=resolution host=other.domain.com ips=1.2.3.4,9.8.7.6>. In this example, trustworthy resolution module 324 may parse or otherwise scan the HTML, and deduce that the host “other.domain.com” may have a DNS resolution of either “1.2.3.4” or “9.8.7.6”. DNS resolutions may also be obtained from or provided within header content, such as within an HTTP headers. For example, a header X-DNSRESOLUTIONS might contain one or more hostnames, and one or more DNS resolutions for each of those host names.

In other cases, DNS resolutions may be obtained from or provided from within HTML, such as an HTML tag field. DNS resolutions may also be provided by a scripting language, such as by calls made to global functions. For example, a call from without JavaScript code to a global function with code such as SuggestResolution(“other.domain.com”,“1.2.3.4”), may provide a plausible DNS resolution. Embedded DNS resolutions may be obtained from or provided by a secure sockets layer (SSL) web link. In some embodiments, the embedded DNS resolutions provided may be for the domain that served the content. Resolutions may be used to re-connect to the server that provided the (presumably alternate) resolution for the domain that served the content. For example, the reconnection may be done using the embedded resolution even if the connection is not SSL based.

Trustworthy resolution module 324 may also obtain an embedded DNS resolution that is closer to a desired domain than a current DNS resolution or IP address for the domain name. For example, a server, such as server 230 may include a “better” IP address for use in future connection back to server 230, the original serving domain. “Better” may mean a server IP address that is closer to a user location, a user's internet provider, a user domain, a browser domain or a server domain. “Closer” may include geographically closer, topologically closer, closer in terms of round-trip-time, closer in terms of improved bandwidth or reliability connectivity, etc. A better or more desirable IP address can provide more responsive or lower latency responses to a user, based on network connectivity. For example, server 230 may serve the same content as server 240, but server 230 is closer and would lead to less latency. Even though a resolution for the domain name is currently an IP address to server 240, a better resolution would point to the IP address of server 230 for the domain name.

Connection module 326 may be configured to establish a connection to another host or server with an obtained or provided DNS resolution, according to an embodiment. An SSL connection may also be established. If a trusted DNS resolution is provided, connections to sub-resource servers for a domain name may be initiated. In some embodiments, a user application, such as browser 210, may rely on content-provided DNS resolutions to initiate connections to a host. In some cases, such embedded resolutions may be used only to initiate SSL connection, such as HTTPS content acquisitions. For example, connections to hosts via HTTP connection may ignore resolutions provided in content.

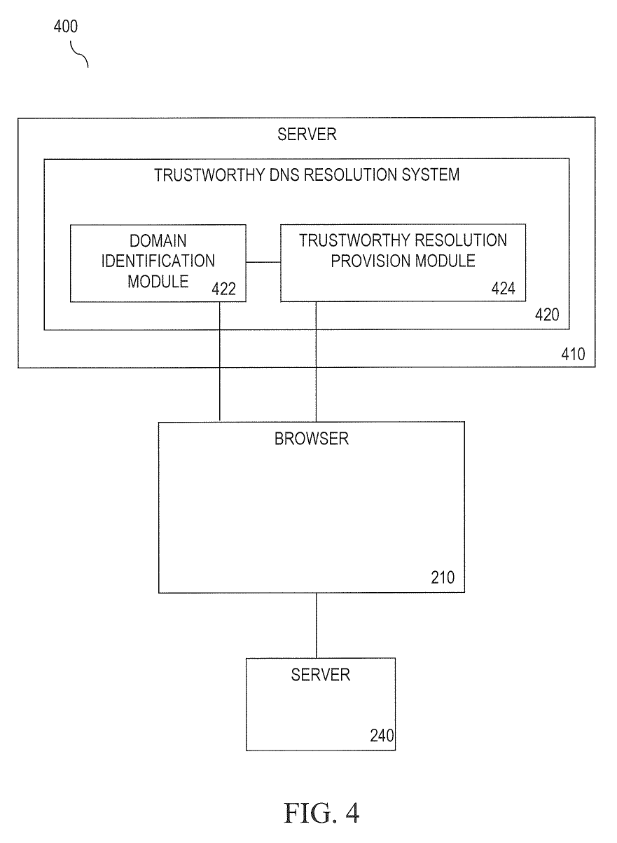

FIG. 4 illustrates an exemplary system 400 for providing trustworthy DNS resolutions, according to an embodiment. System 400 may include browser 210, coupled to server 410 and server 240. Server 410 may include trustworthy DNS resolution system 420, which may include domain identification module 422 and trustworthy resolution provision module 424. These components may be coupled together directly or indirectly. Domain identification module 422 may perform at least the functions of domain identification module 322.

Trustworthy resolution provision module 424 may be configured to provide trusted DNS resolutions in web content, as explained above. Trustworthy provision module 424 may obtain DNS resolutions form other data sources or from requesting DNS resolution prior to identification of a domain name to be resolved. According to an embodiment, web servers, such as HTTP or HTTPS servers, may augment content by including one or more DNS resolutions with the content served as a page. Web search results that included SSL links could be augmented to provide possible IP addresses for given hosts.

In some embodiments extracted resolutions may be stored for possible future use, such as in DNS resolution records. Resolutions may be searched for when the need for a resolution has manifested itself. For example, a DNS resolution may be needed when a connection to a host is required, such as when a user clicks on a web link, or when a sub-resource of a page, such as an image, needs to be fetched. Expiration times may also be included with embedded DNS resolutions.

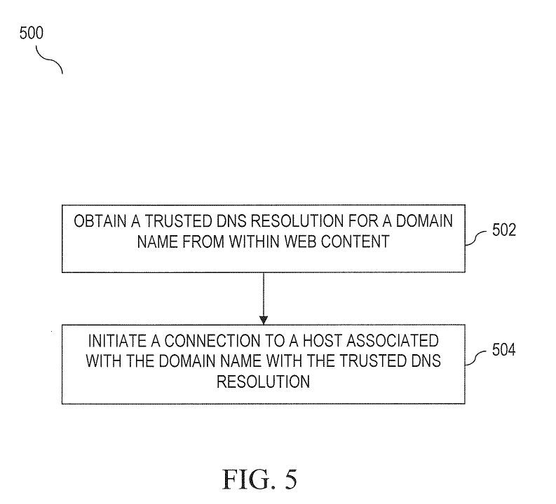

FIG. 5 illustrates an exemplary method 500 for using trustworthy DNS resolutions, according to an embodiment. In step 502, a trusted DNS resolution may be obtained for a domain name from within web content. This step may be performed by trustworthy DNS resolution system 220. In some cases, the domain to be resolved may be identified or provided to trustworthy DNS resolution system 220.

In step 504, a connection to a host associated with the domain name may be initiated with the trusted DNS resolution. This step may be assisted by trustworthy DNS resolution system 220 or connection module 326.

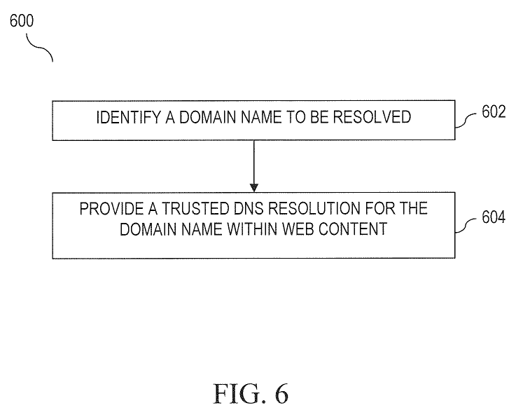

FIG. 6 illustrates an exemplary method 600 for providing trustworthy DNS resolutions, according to an embodiment. In step 602, a domain name to be resolved is identified. Domain identification may be performed by domain identification module 422.

In step 604, a trusted DNS resolution may be provided within web content.

This step may be performed by trustworthy resolution provision module 424. A receiving component may then use the trusted DNS resolution to initiate a connection to a host associated with the domain name. The trusted DNS resolution may also be used to in a SSL connection or for subresources requiring an SSL connection.

The approaches discussed above may benefit web applications that require secure connectivity. Any time there is a need to link to SSL content, such approaches may be used. Perceived latency may be reduced as the steps needed to establish a secure connection are fewer.

Aspects of the embodiments for exemplary systems 200-400, method 500 and/or method 600 or any part(s) or function(s) thereof may be implemented using hardware, software modules, firmware, tangible computer readable or computer usable storage media having instructions stored thereon, or a combination thereof and may be implemented in one or more computer systems or other processing systems.

The embodiments have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

1. A computing device-implemented method for using trustworthy domain name system (DNS) resolutions comprising:
obtaining, by a browser executing on a computing device, a trusted DNS resolution for a domain name within web content without sending a request to a DNS resolver for a DNS resolution of the domain name subsequent to identifying the domain name within the web content; and
initiating a connection to a host associated with the domain name with the trusted DNS resolution.

2. (canceled)

3. The method of claim 1, further comprising automatically validating the trusted DNS resolution during a secure sockets layer (SSL) connection phase.

4. The method of claim 1, wherein the obtaining includes obtaining the trusted DNS resolution for the domain name from within a web page.

5. The method of claim 1, wherein the obtaining includes obtaining the trusted DNS resolution for the domain name from within header content.

6. The method of claim 1, wherein the obtaining includes obtaining the trusted DNS resolution for the domain name from within a hypertext markup language (HTML) tag field.

7. The method of claim 1, wherein the obtaining includes obtaining the trusted DNS resolution for the domain name from a scripting language.

8. The method of claim 1, wherein the obtaining includes obtaining the trusted DNS resolution for the domain name from within a secure sockets layer (SSL) web link.

9. The method of claim 1, wherein the obtaining includes obtaining a particular DNS resolution for the domain name that is closer to a desired domain than a current DNS resolution for the domain name.

10. The method of claim 1, wherein the initiating includes initiating the connection to a secure sockets layer (SSL) enabled sub-resource with the trusted DNS resolution.

11. A computing device-implemented method for providing trustworthy domain name system (DNS) resolutions comprising:
identifying a domain name to be resolved; and
providing, by a browser executing on a computing device, a trusted DNS resolution for the identified domain name within web content, without sending a request to a DNS resolver for a DNS resolution of the identified domain name subsequent to the identifying from the DNS resolver.

12. (canceled)

13. A system for using trustworthy domain name system (DNS) resolutions comprising:
a computing device;
a trustworthy resolution module, implemented within a browser on the computing device, configured to obtain a trusted DNS resolution for a domain name from web content; and
a connection module, implemented within the browser on the computing device, configured to connect to a host associated with the domain name with the trusted DNS resolution without sending a request to a DNS resolver for a DNS resolution of the domain name subsequent to identification of the domain name within the web content.

14. (canceled)

15. The system of claim 13, wherein the connection module is further configured to automatically validate the trusted DNS resolution during a secure sockets layer (SSL) connection phase.

16. The system of claim 13, wherein the trustworthy resolution module is further configured to obtain the trusted DNS resolution from within a web page.

17. The system of claim 13, wherein the trustworthy resolution module is further configured to obtain the trusted DNS resolution from within header content.

18. The system of claim 13, wherein the trustworthy resolution module is further configured to obtain the trusted DNS resolution from within a hypertext markup language (HTML) tag field.

19. The system of claim 13, wherein the trustworthy resolution module is further configured to obtain the trusted DNS resolution from a scripting language.

20. The system of claim 13, wherein the trustworthy resolution module is further configured to obtain the trusted DNS resolution from within a secure sockets layer (SSL) web link.

21. The system of claim 13, wherein the trustworthy resolution module is further configured to obtain a particular DNS resolution for the domain name that is closer to a serving domain than a current DNS resolution for the domain name.

22. The system of claim 13, wherein the connection module is further configured to initiate a connection to a secure sockets layer (SSL) enabled sub-resource with the trusted DNS resolution.

23. A system for providing trustworthy domain name system (DNS) resolutions comprising:
a computing device;
a domain identification module configured to identify a domain name to be resolved; and
a trustworthy resolution provision module, implemented within a browser on the computing device, configured to provide a trusted DNS resolution for the identified domain name within web content without sending a request to a DNS resolver for a DNS resolution of the domain name subsequent to identification of the domain name from a DNS resolver within the web content.

24. (canceled)
